(19) United States
(12) Patent Application Publication
(10) Pub. No.: US 2025/0088787 A1
(43) Pub. Date: Mar. 13, 2025

(54) IN-EAR WEARABLE WITH HIGH LATENCY BAND LIMITING

(71) Applicant: BOSE CORPORATION, Framingham, MA (US)

(72) Inventors: Dale McElhone, Newton, MA (US); Liam Kelly, Brighton, MA (US); Michael j Daley, Shrewsbury, MA (US); Ryan terMeulen, Watertown, MA (US)

(73) Assignee: Bose Corporation, Framingham, MA (US)

(21) Appl. No.: 18/728,754

(22) PCT Filed: Jan. 12, 2023
(86) PCT No.: PCT/US23/10703

§ 371 Date: Jul. 12, 2024

Related U.S. Application Data
(60) Provisional application No. 63/266,826, filed on Jan. 14, 2022.

(51) Int. Cl. H04R 1/10

(52) U.S. Cl. CPC H04R 1/1083; H04R 1/1016

(57) ABSTRACT

An in-car wearable with reduced combing effects is achieved by band limiting the output of a high latency processing path, used to amplify a signal representative of the ambient noise, to frequencies where occlusion and does not occur, and providing those frequencies instead through a low latency processing path.

### BACKGROUND

This disclosure relates to an in-ear wearable with high latency band limiting for reduced combing effects.

### SUMMARY

All examples and features mentioned below can be combined in any technically possible way.

According to an aspect, in-ear wearable includes: a housing; an electroacoustic transducer disposed within the housing, the housing having a first end, the housing being dimensioned such that at least the first end can be inserted into a user's ear canal, wherein the electroacoustic transducer is positioned within the housing to project acoustic energy into the user's ear canal; and a sound processor in electrical communication with the electroacoustic transducer, the sound processor being configured to: generate a first ambient signal representing acoustic energy in an ambient environment, the first ambient signal being generated from a low-latency processing path, wherein the first ambient signal is band limited below a first frequency; generate a second ambient signal representing acoustic energy in the ambient environment, the second ambient signal being generated from a high-latency processing path, wherein the second ambient signal is band limited above the first frequency; and generate a noise-cancellation signal that, when transduced by the electro acoustic transducer, cancels own voice in the user's ear canal below the first frequency.

In an example, the sound processor generates the noise-cancellation signal from, at least, a feedback signal produced by a feedback microphone, the feedback microphone being positioned such that the feedback signal represents acoustic energy the user's ear canal.

In an example, the sound processor is configured to generate a second noise-cancellation signal from, at least, a feedforward microphone.

In an example, wherein the first ambient signal is band limited according to a first filter having a first cut-off frequency at the first frequency, wherein the second ambient signal is band limited according to a second filter having a cut-off frequency at the first frequency.

In an example, wherein the first frequency is in the range of 800 Hz to 1200 Hz.

In an example, wherein the sound processor generates the first ambient signal from, at least, a feedforward signal produced by a feedforward microphone.

In an example, wherein the sound processor generates the second ambient signal from, at least, a second microphone.

In an example, the first ambient signal is generated from, at least, a feedforward signal produced by a feedforward microphone, wherein the sound processor filters the second ambient signal with a filter to minimize an error signal based on the output of the filter and the feedforward signal.

In an example, the sound processor comprises a first processor and a second processor, the first processor generating the first ambient signal and the noise-cancellation signal, the second processor generating the second ambient signal.

In an example, the sound processor is disposed in a housing dimensioned for positioning behind the user's pinna.

According to another aspect, a method for reducing combing in an in ear wearable, the steps of the method being stored in at least one non-transitory storage medium comprising and being executed by a sound processor, the method including: generating a first ambient signal representing acoustic energy in an ambient environment and providing the ambient signal to an electroacoustic transducer, the first ambient signal being generated from a low-latency processing path, wherein the first ambient signal is band limited below a first frequency, wherein the electroacoustic transducer is disposed within a housing, the housing having a first end, the housing being dimensioned such that at least the first end can be inserted into a user's ear canal, wherein the electroacoustic transducer is positioned within the housing to project acoustic energy into the user's ear canal; generating a second ambient signal representing acoustic energy in the ambient environment and providing the second ambient signal to the electroacoustic transducer, the second ambient signal being generated from a high-latency processing path, wherein the second ambient signal is band limited above the first frequency; and generating a noise-cancellation signal and providing the noise-cancellation signal to the electroacoustic transducer, the noise-cancellation signal being configured such that when transduced by the electro acoustic transducer, cancels own voice in the user's ear canal below the first frequency.

In an example, the noise-cancellation signal is generated from, at least, a feedback signal produced by a feedback microphone, the feedback microphone being positioned such that the feedback signal represents acoustic energy the user's ear canal.

In an example, the method further comprising the step of generating a second noise-cancellation signal from, at least, a feedforward microphone.

In an example, the first ambient signal is band limited according to a first filter having a first cut-off frequency at the first frequency, wherein the second ambient signal is band limited according to a second filter having a cut-off frequency at the first frequency.

In an example, the first frequency is in the range of 800 Hz to 1200 Hz.

In an example, the first ambient signal is generated from, at least, a feedforward signal produced by a feedforward microphone.

In an example, the second ambient signal is generated from, at least, a second microphone.

In an example, wherein the first ambient signal is generated from, at least, a feedforward signal produced by a feedforward microphone, wherein the sound processor filters the second ambient signal with a filter to minimize an error signal based on the output of the filter and the feedforward signal.

In an example, the sound processor comprises a first processor and a second processor, the first processor generating the first ambient signal and the feedback signal, the second processor generating the second ambient signal.

In an example, the sound processor is disposed in a housing dimensioned for positioning behind the user's pinna.

The details of one or more implementations are set forth in the accompanying drawings and the description below. Other features, objects, and advantages will be apparent from the description and the drawings, and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various aspects.

FIG. 1 depicts a perspective view of a hearing aid, according to an example.

FIG. 2 depicts a schematic view of a hearing aid, according to an example.

FIG. 3 depicts a block diagram of the processing paths of a hearing aid, according to an example.

FIG. 4A depicts insertion gain of own voice with and without active noise reduction, according to an example.

FIG. 4B depicts insertion gains of: own voice without active noise cancellation, own voice with active noise cancellation, a band-limited low latency path, and a band-limited high latency path, according to an example.

FIG. 4C depicts insertion gains of: own voice without active noise cancellation, own voice with active noise cancellation, a band-limited low latency path, and a band-limited high latency path, according to an example.

FIG. 4D depicts insertion gains of: own voice without active noise cancellation, own voice with active noise cancellation, a band-limited low latency path, and a band-limited high latency path, according to an example.

FIG. 5A depicts a block diagram of the processing paths of a hearing aid, according to an example.

FIG. 5B depicts a block diagram of the processing paths of a hearing aid, according to an example.

FIG. 5C depicts a block diagram of the processing paths of a hearing aid, according to an example.

FIG. 5D depicts a partial block diagram of the processing paths of a hearing aid, according to an example.

### DETAILED DESCRIPTION

Various examples disclosed are related to a device and method for reducing combing artifacts in an in-ear wearable through band limiting high latency audio processing paths.

Hearing aids sometimes employ active noise reduction to reduce occlusion or to otherwise offer greater control of the volume of the outside world. Occlusion is the amplification lower-frequency components of the user's own voice that arise due to the acoustic blockage of the car canal by the hearing aid. Occlusion is often perceived as “boomy” or “muffled.” Active noise reduction can be employed to reduce occlusion by canceling the lower frequency components present in the user's ear canal resulting from own voice. But the residual low frequency components, i.e., those remaining after cancellation, can combine with the output of the hearing aid amplification within the car canal to result in undesirable combing effects. This is because the hearing aid amplification can be the result of a complex filtering output that introduces a relatively high latency to amplified acoustic signal, meaning that the amplified acoustic signal is delayed often by as much as three or four milliseconds. The delayed output signal of the high-latency amplification path combines with the residual low-frequency components of the active noise cancellation (also referred to in this disclosure as active noise reduction) in a manner that creates the combing artifacts frequently-often perceived as being “echoey” since the user is hearing own voice naturally and then again approximately 3 ms later.

In various examples described below, the high-latency path can be band limited so that the low frequency components where the combing occurs (e.g., approximately less than 1 kHz) are filtered out. Rather than being introduced through the high-latency path, these ambient low-frequency components can be added via a low-latency path. Adding these components via the low latency path does not create the same combing artifacts that result from the high-latency path, since its output is not similarly delayed. To avoid producing the same signal via both the low-latency path and the high-latency path, the low-latency path can likewise be band limited to filter out frequencies at which the high-latency path is producing acoustic energy (e.g., approximately greater than 1 kHz).

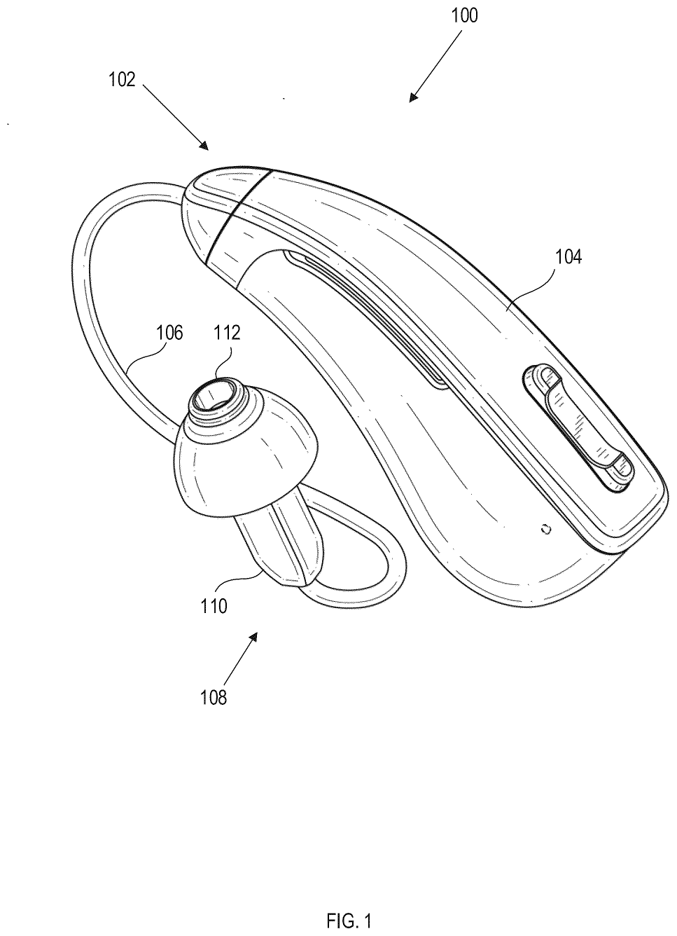

With reference to FIG. 1, a perspective view of a receiver-in-canal (RIC) hearing aid 100 is shown. Hearing aid 100 comprises a behind-the-car portion 102 housing a battery, a microphone, and a sound processor in a casing 104 designed to sit behind a user's ear (pinna). This behind-the-car portion 102 of the hearing aid 100 has a small wire 106 designed to run around the user's ear and into an earpiece 108 that has at least one end designed to sit in the user's ear canal. The earpiece 108 includes an earbud 110 that carries an electroacoustic transducer, also known as the “speaker, “receiver,” or “driver.” Conventional RIC style hearing aids often further include a compliant tip 112 on the ear bud 110 for engaging the user's ear canal, which helps to keep earpiece 108 in place.

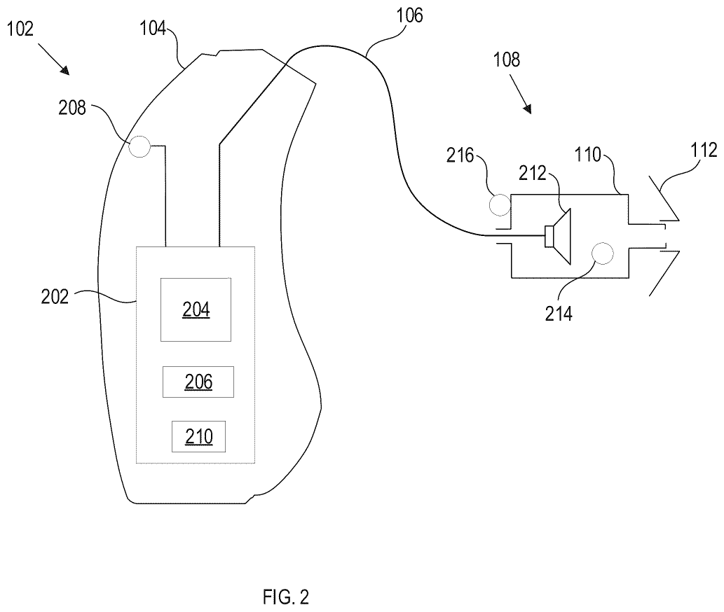

FIG. 2 depicts an example of a schematic diagram of hearing aid 100. In this example, casing 104 houses electronics 202, including a sound processor 204, a battery 206 for powering electronics 202, and a microphone 208. In some cases, microphone 208 can comprise a plurality of microphones that can be arranged in an array. Electronics 202 can also include a transceiver 210, which, for example, can be used for wireless communication with another device such as a mobile device or another hearing aid.

Earpiece 108 includes electroacoustic transducer 212, which, as will be described in greater detail below, receives and transduces one or more electrical signals into acoustic signals that are projected into the user's ear canal. In various examples, electroacoustic transducer 212 can be implemented as a plurality of electroacoustic transducers for producing the acoustic signals. Earpiece 108 further includes a feedback microphone 214 configured and positioned to produce an electrical signal representative of acoustic energy present in a user's ear canal, and a feedforward microphone 216 configured and positioned and configured to produce an electrical signal representative of acoustic energy present at the user's concha. Feedback microphone 214 and feedforward microphone 216 can each be implemented as one or more microphones.

Sound processor 204 receives a microphone signal from microphone 208 and performs one or more amplification and processing operations before providing the amplified microphone signal to electroacoustic transducer 212 for transduction into an acoustic signal. In various examples, processes performed by the sound processor include beam steering, null forming, gain, compression, and/or active noise cancellation. Sound processor 204 can further receive signals from feedback microphone 214 and feedforward microphone 216 for use in generating noise-cancellation signals, in addition to the amplified microphone signal, to be transduced by electroacoustic transducer 212. The noise-cancellation signals are approximately 180° out of phase with the undesired noise and thus destructively interfere with the undesired noise (resulting in a reduction in undesired noise, as perceived by the user, of at least 3 dB).

More particularly, sound processor 204 can be implemented as one or more processors (including microprocessors, application-specific integrated circuits, and other suitable forms of digital processing) in conjunction with any associated hardware. To perform the various operations described above (including beam steering, null forming, gain, compression, active noise cancellation) sound processor 204 can execute instructions stored in one or more non-transitory storage medium. In various examples, the sound processor 204 can implement one or more adaptive filters, such as a least means squares (LMS) adaptive filter or a recursive least squares filter (RLS) adaptive filter, to perform the adaptive active noise cancellation algorithm. These adaptive filters can employ the signal from the feedback microphone 214 as an error signal, as will be understood by a person of ordinary skill in the art. Sound processor 204 generates a noise-cancellation signal that is provided to the electroacoustic transducer 212, such that the electroacoustic transducer 212 renders an acoustic noise-cancellation signal that deconstructively interferes with undesired noise in the user's ear canal. Additionally, the signal from feedforward microphone 216, or from another microphone (e.g., microphone 208), can be employed by sound processor 204 in a feedforward active noise cancellation algorithm to cancel undesired noise as perceived by the user.

In an alternative example, some or all of electronics 202 can be housed within earpiece 108 or earbud 110 (in one such example, behind-the-car portion 102 can thus be excluded) or can be distributed between behind-the-car portion 102, earpiece 108, or a housing attached to earpiece 108. For example, in the in-the-car or the in-the-canal form factors, electronics 202 and sound processor 204 can be positioned within the housing of the earpiece, either in the earbud or in the casing adjacent to the concha of the user's ear when worn. Further, in alternative examples, the concepts disclosed here can be used in non-hearing aid implementations, such as in earbuds that include a hear-through feature. Indeed, the concepts disclosed herein can be used in any in-car wearable providing some form of high latency reproduction of the ambient environment and having a form factor that creates some degree of occlusion.

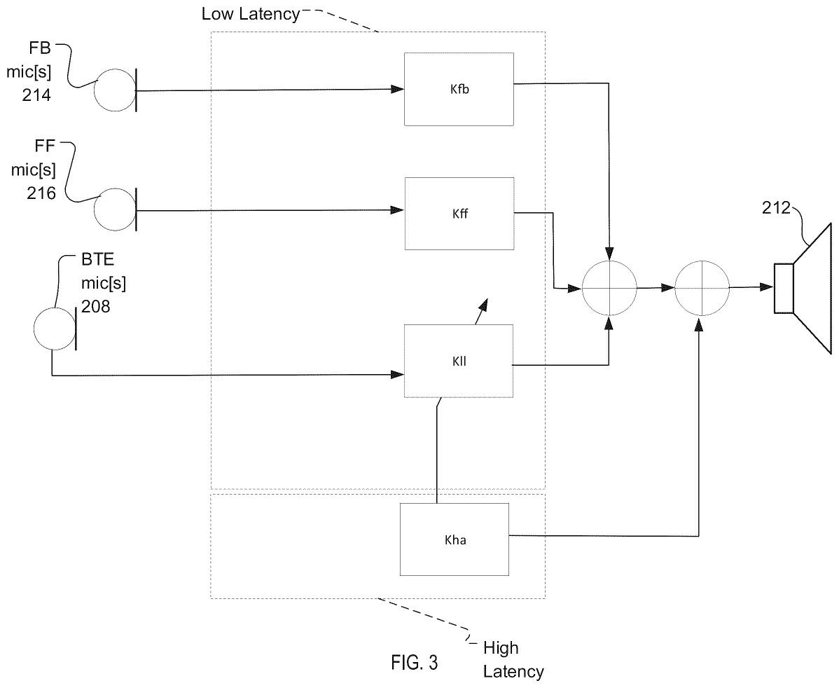

FIG. 3 depicts an example block diagram of the processes implemented by sound processor 204. As shown, sound processor 204 implements amplification and active noise cancelling processes that fall into to two broad categories: high latency and low latency processes. Starting at the bottom, microphone 208 feeds into a filter labeled Kha. Kha is applied to microphone 208 to output a signal representative of the user's ambient environment at high frequencies (above approximately 1 kHz), for reasons described in greater detail below. Kha is a relatively complex filter that can perform various processes such as beam steering, null forming, gain, and compression (some of which are non-linear processes) and thus introduces a relatively high latency (e.g., >3 ms). The parameters of Kha can be modulated by environmental input or user input settings, including settings that adjust gain or apply some form of dynamic range compression to increase the intelligibility of spoken word inputs or to achieve some other desired shaping of the signal.

The output of the high latency processes is combined with the output of low latency processes, which, in the example of FIG. 3, comprise three separate processing paths. Kll is the filter applied to feedforward microphone 216, used to process the acoustic energy detected by feedforward microphone 216. In its simplest form, Kll can be understood as a filter that restores low frequency (below approximately 1 kHz) content in the user's ear with minimal latency while ANC is active (according to filters Kff and/or Kfb, as described below). Like Kha, Kll can also be modulated by environmental input or user's input settings, including settings that adjust gain or apply some form of dynamic range compression to increase the intelligibility of spoken word inputs or to achieve some other desired shaping of the signal. Various environmental inputs can be used to adjust the gain of the Kll. For example, if the ambient environment is 80 dB SPL, the gain of Kll might be reduced to 10 dB less low frequency gain than if the ambient environment is 50 dB SPL. In another or the same example, if a loud sound like a door slam is detected, or if wind is detected, the gain of Kll can be quickly reduced. In another or the same example, if low frequency steady state noise is detected, the low frequency gain can be reduced. In short, the gain of Kll can adjusted according to the nonlinear processing performed by the Kha in the high-latency path.

In addition to the Kha and Kll processes, which provide signals representative of the user's ambient environment, sound processor 204 implements active noise cancellation via two additional processing paths. The first of these, with filter Kff, is active noise cancellation using the feedfoward signal from feedforward microphone 216. The second filter, Kfb, is active noise cancellation using the feedback signal from feedback microphone 214. Kff and Kfb can be each be implemented according to known noise-cancellation algorithms, such as LMS or RLS. The low-latency processes can typically be performed at speeds less than 1 ms.

As mentioned above, sound processor 204 can be implemented by one or more processors in conjunction with any associated hardware. In an example, the high latency processing can be performed by a first processor and the low-latency processing can be performed by a second processor, which, acting in concert to produce the signals transduced by electroacoustic transducer 212, form sound processor 204. Other variations and permutations of processors/circuitry are contemplated to form sound processor 204.

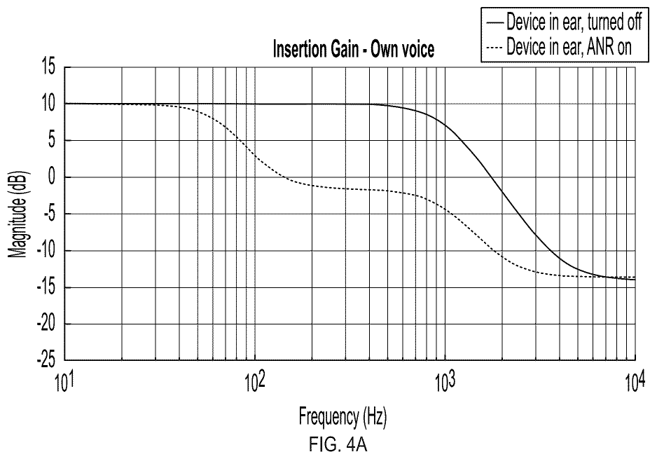

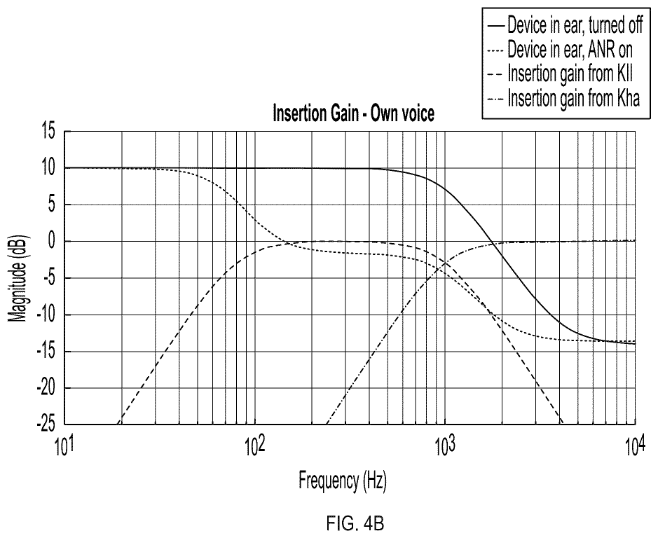

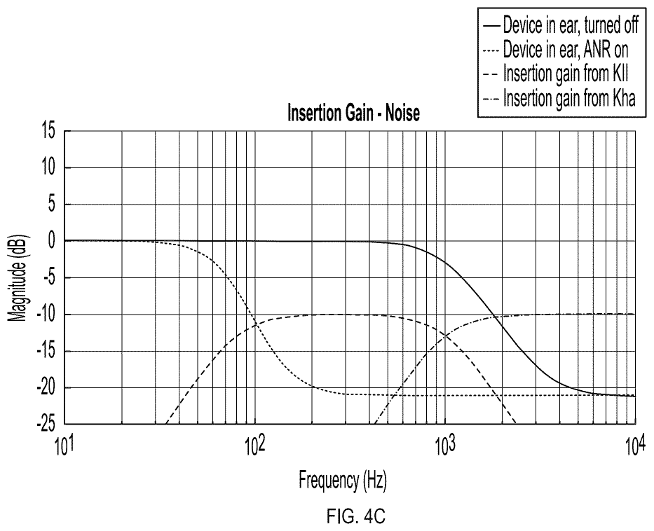

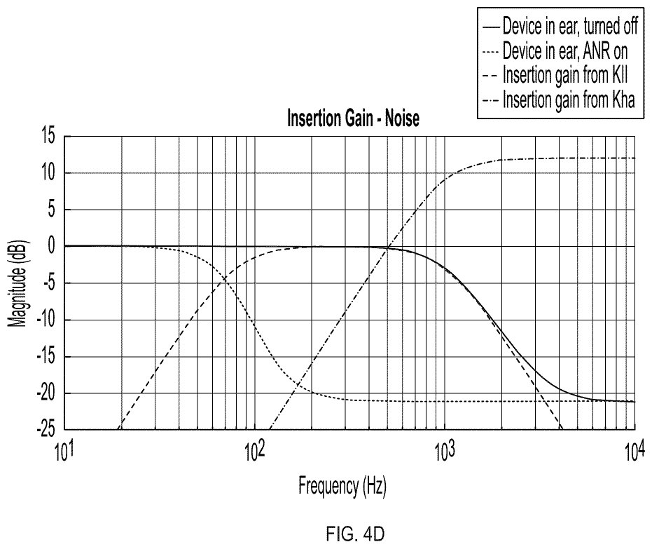

FIGS. 4A and 4B depict simulated examples of the insertion gain of own voice with and without the ambient sound outputs and active noise cancellation. Beginning at FIG. 4A, the insertion gain of the user's own voice is depicted with and without active noise reduction. As shown, the user's own voice is amplified at 10 dB since the isolation effected by earpiece 108 increases pressure in the car canal, creating the increased boominess known as occlusion. This is sharply reduced through active noise reduction: signals above approximately 100 Hz are attenuated to approximately 0 dB. (The exact frequencies and response of the noise-cancellation will depend upon the type and nature of the noise-cancellation algorithm implemented.)

The active noise reduction, however, also attenuates signals from the ambient environment, which, in a hearing aid, is typically not desirable. Thus, as shown in FIG. 4B, the ambient signals from the processing paths with filters Kha and Kll are introduced to provide signals representative of ambient acoustic energy to the user. As mentioned above, however, if the full bandwidth from the high-latency Kha filter is produced, combing artifacts will result from band interactions with the residual noise. In this example, combing is accordingly reduced by band-limiting the high latency ambient signal to above approximately 1000 Hz. The ambient acoustic energy below approximately 1000 Hz is instead produced by the low-latency Kha filter. Stated differently, Kha includes a high pass filter with a corner frequency at 1000 Hz and Kll includes a low pass filter with a corner frequency at approximately 1000 Hz. In this way, the delayed output of Kha is not combined with the residual noise remaining from the active noise reduction and the resulting combing artifacts are avoided. The output from the Kll low latency path, since it is not similarly delayed, does not create the same combing artifacts and the user's experience is improved.

In the example described above, Kll and Kha implement a cut off frequency at approximately 1000 Hz. (Kha reducing frequency content below approximately 1000 Hz and Kll reducing frequency content above approximately 1000 Hz.) For the purposes of this disclosure approximately 1000 Hz means a frequency range from 500 Hz to 1500 Hz, and thus the cut offs can be adjusted to any point within that range. This has been shown to result in good performance with reduced combing. Further, in various examples, Kha and Kll can use different cut off frequencies. For example, Kha can comprise a high pass filter having a cut off of 800 Hz and Kll can comprise a low pass filter having a cut off of 1200 Hz so that the outputs have considerable spectral overlap.

As described above, gains of filters Kha and Kll can be adjusted to increase or decrease the volume of the ambient sound perceptible to the user according to user or environmental inputs. For example, as shown in FIG. 4C, the volume of the ambient signals can be reduced to approximately −10 dB, for a user who would like to turn down ambient noise. Likewise, both can be increased to turn up the volume of the ambient sound (as is often required for a user with diminished hearing.) In addition, Kha and Kll can implement different gains. For example, as shown in FIG. 4D, the gain of Kha can be increased to provide amplification of high frequencies, while the gain of Kll is left at 0 dB. Likewise, the gain of Kll can be decreased or increased relative to Kha to increase or decrease low-frequency content. (Note that while FIGS. 4A and 4B depict the insertion gain of own voice, FIGS. 4C and 4D depict the insertion gain of noise in general.) It should also be understood that the flat spectral shapes of the filters are merely provided to give general examples of the concepts illustrated herein, and are not meant to limit the sort of spectral shaping implemented by filters Kha and Kll.

Further although two processing paths for reproducing the ambient acoustic energy are shown, any number of processing paths can be used. Generally speaking, to reduce the combing effect, it is only necessary to spectrally limit the frequency of high latency outputs to above the frequencies where occlusion occurs. Accordingly, if multiple high latency processing paths are used to create good performance reproduction of the ambient sound, each of these can be spectrally limited to above the frequencies at which occlusion occurs.

In some examples, the high latency outputs can be spectrally limited to below frequencies where occlusion occurs, but these will suffer from some amounts of combing. Additionally, it is not strictly necessary to provide a low latency output (e.g., Kll) for frequencies below the band limited ambient signal (e.g., Kha). However, failing to provide a low latency output will result in some undesirable exclusion of low frequency content, since this content is cancelled with the active noise reduction. Further, it is not necessary that both feedback and feedforward noise cancelling is used. Although feedback offers the highest quality reduction in occlusion, in various examples, only feedback or only feedforward active noise can be employed.

Although the low latency path is shown receiving a signal from feedforward microphone 216, and the high latency path is shown receiving a signal from behind-the-ear microphone 208, it should be understood that, in alternative examples, both the high latency path and low latency path can receive the same signals (e.g., from only behind-the-car microphone 208, from only feedforward microphone 216, or some combination thereof).

In various alternative examples, feedforward microphone 216 can be used in conjunction with the behind-the-car microphone 208 to better approximate the spectral shaping accomplished by the user's pinna. Stated differently, although behind-the-ear microphones are better positioned to capture ambient acoustic energy than feedforward microphone 216, they do not receive the same acoustic reflections from the interior of the user's pinna, and thus the quality of the audio does not match the nature of the audio to which the user is accustomed. This can be remedied by using the feedforward microphone 216 as an error signal to adjust the output(s) of behind-the-car microphone 208.

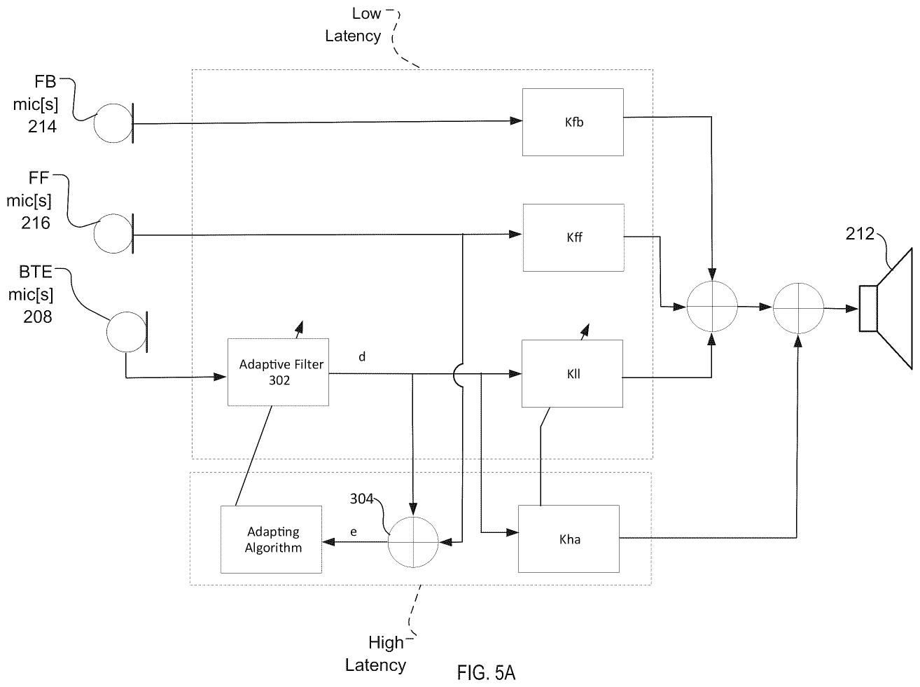

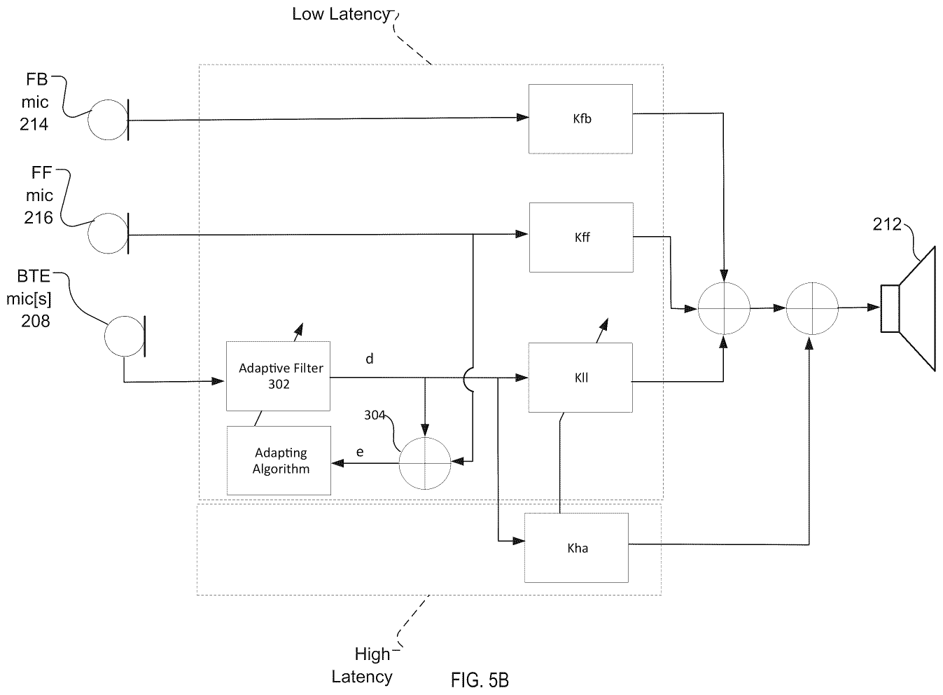

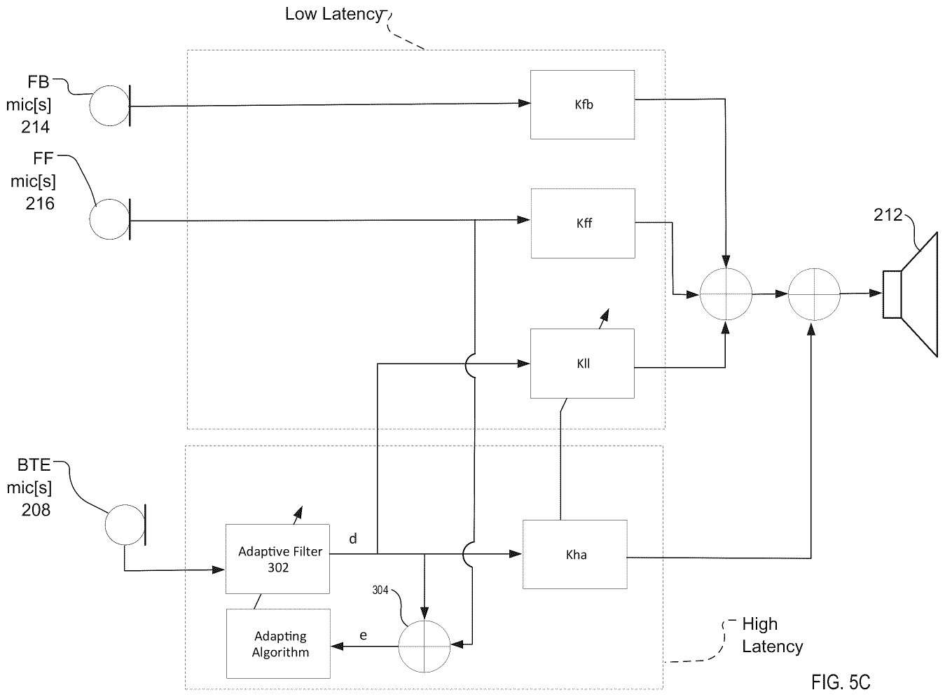

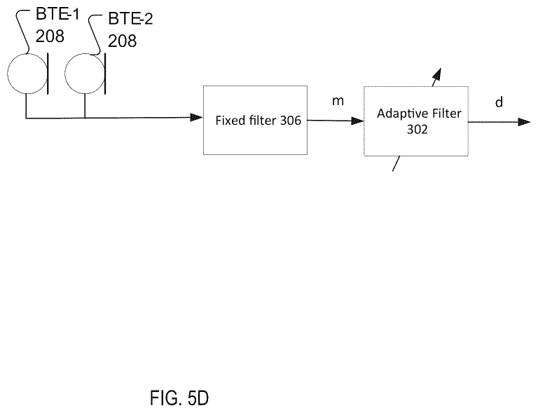

For example, as shown in FIG. 5A, in order to modify the behind-the microphone 208 signal such that it more closely resembles the feedback microphone signal, an adaptive filter 302 is used. In one example, the adaptive filter 302 is a least mean squares (LMS) filter (although other filter algorithms, such as RLS can be used). The adaptive filter 302 receives the behind-the-car microphone signal and an error signal e. The error signal e is generated by a subtractor circuit 304, and is the difference between the feedback microphone signal and the output of the adaptive filter 302, adapted signal d. The error signal e is then fed back to the adaptive filter 302 (i.e., the error signal e is fed back to an adapting algorithm that calculates updated coefficients for the adaptive filter 302), dynamically adjusting the adaptive filter 302 to produce an adapted signal d as close to the feedback microphone 216 signal as possible. This adapted signal d is then provided to filters Kll and Kha for further processing, as described above.

FIGS. 5B and 5C depict variations in where the adaptation or the filtering is processed. Whereas in FIG. 5A the adaptation logic is performed in the high latency processor of sound processor 204, in the variation of FIG. 5B, the adaptation logic and filtering is performed entirely in the low latency processor. In both FIG. 5A and FIG. 5B the behind-the-car microphone ADC can read into the low-latency processor such that adaptation occurs at a fast rate. In the variation of FIG. 5A, however, the feedforward microphone ADC is read by the high-latency processor, such that the adaptation occurs in the high-latency processor and is provided to the low-latency processor and interpolated. The example of FIG. 5A adds some delay that favors implementation simplicity over system performance. In FIG. 5B, the adaptation occurs in the low latency processor, which offers better system performance at the expense of greater implementation complexity. The example of FIG. 5C, in which the adaptation and filtering occurs entirely within the high latency processor, likely offers the worst performance but still provides an improvement over using behind-the-car microphones alone.

FIG. 5D depicts a variation of FIGS. 5A-5C in which the behind-the-car microphone 208 is implemented as two behind the car microphones, BTE-1 208, BTE-2 208, which are arranged as a directional microphone array. (Any number of behind-the-car microphones can similarly be arranged as a directional microphone array.) In an example, a fixed filter 306 receives the first BTE microphone 208 signal and the second BTE microphone 208 signal and generates a corresponding microphone array signal m. The microphone array signal m may be a beamformed signal corresponding to the desired direction of the directional array formed by the BTE microphones 208. The microphone array signal m is then provided to the adaptive filter 302. As described in connection with FIGS. 5A-5C, the output of the adaptive filter 302, adapted signal d, is adjusted according to error signal e, the difference between the adapted signal d and front-of-car microphone signal 216. The adapted signal d is then processed by filters Kha and Kll. In various alternative examples, the beamforming (e.g., fixed filter 306) can be implemented by either the high-latency processor or the low-latency processor.

The process of filtering the behind-the-car microphone signal output to more closely resemble the acoustic energy within the user's pinna is described in more detail in Application Ser. No. 63/266,785, filed concurrently herewith and titled “Systems and Methods for Adapting Audio Captured by Behind-The-Ear Microphones,” the entirety of which is incorporated by reference.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

What is claimed is:

1. An in-ear wearable comprising:
a housing;
an electroacoustic transducer disposed within the housing, the housing having a first end, the housing being dimensioned such that at least the first end can be inserted into a user's ear canal, wherein the electroacoustic transducer is positioned within the housing to project acoustic energy into the user's ear canal; and
a sound processor in electrical communication with the electroacoustic transducer, the sound processor being configured to:
generate a first ambient signal representing acoustic energy in an ambient environment, the first ambient signal being generated from a low-latency processing path, wherein the first ambient signal is band limited below a first frequency;
generate a second ambient signal representing acoustic energy in the ambient environment, the second ambient signal being generated from a high-latency processing path, wherein the second ambient signal is band limited above the first frequency; and
generate a noise-cancellation signal that, when transduced by the electro acoustic transducer, cancels own voice in the user's ear canal below the first frequency.

2. The in-ear wearable of claim 1, wherein the sound processor generates the noise-cancellation signal from, at least, a feedback signal produced by a feedback microphone, the feedback microphone being positioned such that the feedback signal represents acoustic energy the user's ear canal.

3. The in-ear wearable of claim 1, the sound processor is configured to generate a second noise-cancellation signal from, at least, a feedforward microphone.

4. The in-ear wearable of claim 1, wherein the first ambient signal is band limited according to a first filter having a first cut-off frequency at the first frequency, wherein the second ambient signal is band limited according to a second filter having a cut-off frequency at the first frequency.

5. The in-ear wearable of claim 1, wherein the first frequency is in the range of 800 Hz to 1200 Hz.

6. The in-ear wearable of claim 1, wherein the sound processor generates the first ambient signal from, at least, a feedforward signal produced by a feedforward microphone.

7. The in-ear wearable of claim 1, wherein the sound processor generates the second ambient signal from, at least, a second microphone.

8. The in-ear wearable of claim 6, wherein the first ambient signal is generated from, at least, a feedforward signal produced by a feedforward microphone, wherein the sound processor filters the second ambient signal with a filter to minimize an error signal based on the output of the filter and the feedforward signal.

9. The in-ear wearable of claim 1, wherein the sound processor comprises a first processor and a second processor, the first processor generating the first ambient signal and the noise-cancellation signal, the second processor generating the second ambient signal.

10. The in-ear wearable of claim 1, wherein the sound processor is disposed in a housing dimensioned for positioning behind the user's pinna.

11. A method for reducing combing in an in ear wearable, the steps of the method being stored in at least one non-transitory storage medium comprising and being executed by a sound processor, the method comprising:
generating a first ambient signal representing acoustic energy in an ambient environment and providing the ambient signal to an electroacoustic transducer, the first ambient signal being generated from a low-latency processing path, wherein the first ambient signal is band limited below a first frequency, wherein the electroacoustic transducer is disposed within a housing, the housing having a first end, the housing being dimensioned such that at least the first end can be inserted into a user's ear canal, wherein the electroacoustic transducer is positioned within the housing to project acoustic energy into the user's ear canal;
generating a second ambient signal representing acoustic energy in the ambient environment and providing the second ambient signal to the electroacoustic transducer, the second ambient signal being generated from a high-latency processing path, wherein the second ambient signal is band limited above the first frequency; and
generating a noise-cancellation signal and providing the noise-cancellation signal to the electroacoustic transducer, the noise-cancellation signal being configured such that when transduced by the electro acoustic transducer, cancels own voice in the user's ear canal below the first frequency.

12. The method of claim 11, wherein the noise-cancellation signal is generated from, at least, a feedback signal produced by a feedback microphone, the feedback microphone being positioned such that the feedback signal represents acoustic energy the user's ear canal.

13. The method of claim 11, further comprising the step of generating a second noise-cancellation signal from, at least, a feedforward microphone.

14. The method of claim 11, wherein the first ambient signal is band limited according to a first filter having a first cut-off frequency at the first frequency, wherein the second ambient signal is band limited according to a second filter having a cut-off frequency at the first frequency.

15. The method of claim 11, wherein the first frequency is in the range of 800 Hz to 1200 Hz.

16. The method of claim 11, wherein the first ambient signal is generated from, at least, a feedforward signal produced by a feedforward microphone.

17. The method of claim 11, wherein the second ambient signal is generated from, at least, a second microphone.

18. The method of claim 16, wherein the first ambient signal is generated from, at least, a feedforward signal produced by a feedforward microphone, wherein the sound processor filters the second ambient signal with a filter to minimize an error signal based on the output of the filter and the feedforward signal.

19. The method of claim 11, wherein the sound processor comprises a first processor and a second processor, the first processor generating the first ambient signal and the feedback signal, the second processor generating the second ambient signal.

20. The method of claim 11, wherein the sound processor is disposed in a housing dimensioned for positioning behind the user's pinna.
